(19) United States
(12) Patent Application Publication
(10) Pub. No.: US 2007/0057575 A1
(43) Pub. Date: Mar. 15, 2007

(54) Vertical idler adjuster for track-type work machine

(76) Inventors: Everett G. Brandt, Brimfield, IL (US); Roger L. Recker, Dunlap, IL (US); Richard E. Livesay, Peoria, IL (US); Glen A. Spindel, Divernon, IL (US); Kelly A. Scholz, Peoria, IL (US); Christophe Grandouiller, Grenoble (FR); Daniel L. Mikrut, Chillicothe, IL (US)

Correspondence Address: CATERPILLAR c/o LIELL & MCNEIL ATTORNEYS PC, P.O. BOX 2417, 511 SOUTH MADISON STREET, BLOOMINGTON, IN, 47402-2417, US

(21) Appl. No.: 11/227,647

(22) Filed: Sep. 15, 2005

(51) Int. Cl. B62D 55/14

(52) U.S. Cl. 305/136

(57) ABSTRACT

The present disclosure provides a track-type work machine including a vertical idler adjuster, a track-type work machine including a roller frame and an idler mounted proximate an end of the roller frame. The idler includes an idler shaft, and at least one support block supports the idler shaft. One or both of the idler shaft and the at least one support block includes a plurality of assembly orientations corresponding to different idler heights relative to the roller frame.

### TECHNICAL FIELD

The present disclosure relates generally to track-type work machines, and relates more particularly to a track-type work machine having a vertical idler adjuster.

### BACKGROUND

Track type work machines are in widespread use in construction, mining, forestry, and similar industries. In particular, bulldozers, cranes and pavers are commonly seen track type work machines along roads, freeways and at construction sites. “Tracks” rather than wheels are typically used on work machines operating in environments where creating sufficient traction with conventional tires is problematic or impossible. Rather than rolling across a work surface on wheels, track type work machines utilize one or more tracks extending about a plurality of rolling elements. Such tracks are typically made up of a loop of coupled metal links having outer sides that engage the ground or work surface, and inner sides travelling about the rolling elements, which can include various drive rollers, support rollers, tensioners and “idlers.”

An idler in a track type work machine is a rolling element that passively rolls against the inner side of the track, and can have a plurality of teeth much like a gear wheel that engage against the bushings joining the track links. The idler is typically positioned at an opposite end of the track roller frame to a drive wheel or sprocket, and supports that end of the track during operation. Rollers are typically positioned between the idler and the sprocket, and support the inner side of the track opposite the ground.

Over the course of work machine operation, the various moving parts of the track assembly can undergo significant wear. The track links, rollers, idlers and drive sprockets can all experience wear from the nearly constant metal-to-metal contact. For example, the idler can include grooves or pockets separating the teeth. A phenomenon known in the art as “tooth root wear” describes deepening of these pockets over time due to repetitive engagement and disengagement with the track, which in turn wears due to its corresponding engagement against the idler. A horizontal plane, located at the bottom of the idler, and intersecting bushings in the track can be defined as the idler plane. As the idler and bushings wear, the idler plane can actually migrate. The rollers will also tend to wear down as they operate against the track links over time. The “roller plane” may be thought of as a horizontal plane located at the bottom of the rollers, and intersecting bushings in the track. In a manner similar to the idler plane, wear of the track links and rollers can actually cause the roller plane to migrate.

In many common work machines, the idlers, rollers and track links have traditionally been made of similar materials, for example steel, and thus the various elements have a tendency to wear at approximately the same rate. Accordingly, the relative distance between the roller plane and idler plane remains roughly the same over the course of many hours of operation. In the past, servicing of the work machine and replacement of the idlers, rollers and in some instances track links would take place at predetermined intervals, based generally on similar wear rates of the same.

In an attempt to prolong the life of certain of the work machine components, in recent years designers have begun to employ rotating bushings connecting side by side track links, and toothed idlers running on the rotating bushings. The wear rate of rotating bushings is relatively slow, as the rotating bushings can roll into and out of engagement with the other components rather than sliding. The rate of migration/translation of the idler plane is a function primarily of tooth root wear and rotating bushing wear, whereas the rate of migration/translation of the roller plane is a function primarily of roller wear and track link wear. Tooth root wear and rotating bushing wear tends to be slower than roller and link wear, and consequently the rate of change in the position of the idler plane tends to be slower than the rate of change in the position of the roller plane.

Where the rate of change in position of the roller plane outpaces the rate of change in the idler plane, the relative separation of the respective planes can change over time. For many work machine operations, it is desirable to maintain the roller plane and idler plane substantially at constant positions relative to one another. For example, if the idler plane lies at an inappropriate position relative to the roller plane, the ride, blade control or work surface finish can be compromised in certain operations.

The present disclosure is directed to one or more of the problems or shortcomings set forth above.

### SUMMARY OF THE DISCLOSURE

In one aspect, the present disclosure provides a track-type work machine including a roller frame, and an idler mounted proximate an end of the roller frame. The idler includes an idler shaft, and at least one support block supporting the idler shaft. One or both of the idler shaft and the at least one support block include a plurality of assembly orientations corresponding to different idler heights relative to the roller frame.

In another aspect, the present disclosure provides an idler mounting apparatus for a track-type work machine. The idler mounting apparatus includes a roller frame, an idler yoke disposed proximate an end of the roller frame, and a rotatable idler supported in the idler yoke, the rotatable idler including an idler shaft. First and second support blocks are provided and support the idler shaft. At least one of the idler shaft and the first and second support blocks includes a plurality of assembly orientations corresponding to a plurality of vertical idler positions relative to the roller frame.

In still another aspect, the present disclosure provides a method of vertically adjusting a rotatable idler in a track-type work machine. The method includes the steps of relieving pressure on the idler, and re-orienting at least one of an idler shaft and at least one support block supporting the idler shaft. The step of re-orienting vertically repositions the idler shaft relative to a roller frame of the work machine, the method further including the step of returning pressure to the idler.

### BRIEF DESCRIPTION OF THE DRAWINGS

FIG. 1 is a side perspective view of a work machine including a vertical idler adjuster according to the present disclosure;

FIG. 2 is a sectioned diagrammatic view in perspective of a vertical idler adjuster according to one embodiment of the present disclosure;

FIG. 3 is a partially sectioned diagrammatic end view of a vertical idler adjuster according to another embodiment of the present disclosure;

FIG. 4 is a sectioned diagrammatic end view of a vertical idler adjuster according to yet another embodiment of the present disclosure;

FIG. 5 is a side diagrammatic view of a vertical idler adjuster according to yet another embodiment of the present disclosure;

FIG. 6a is a perspective view of one component of the vertical idler adjuster of FIG. 5;

FIG. 6b is a perspective view of a second component of the vertical idler adjuster of FIG. 5;

FIG. 7a is a perspective view of a third component of the vertical idler adjuster of FIG. 5;

FIG. 7b is a perspective view of a fourth component of the vertical idler adjuster of FIG. 5;

FIG. 7c is a side diagrammatic view of the components of FIGS. 7a-b.

### DETAILED DESCRIPTION

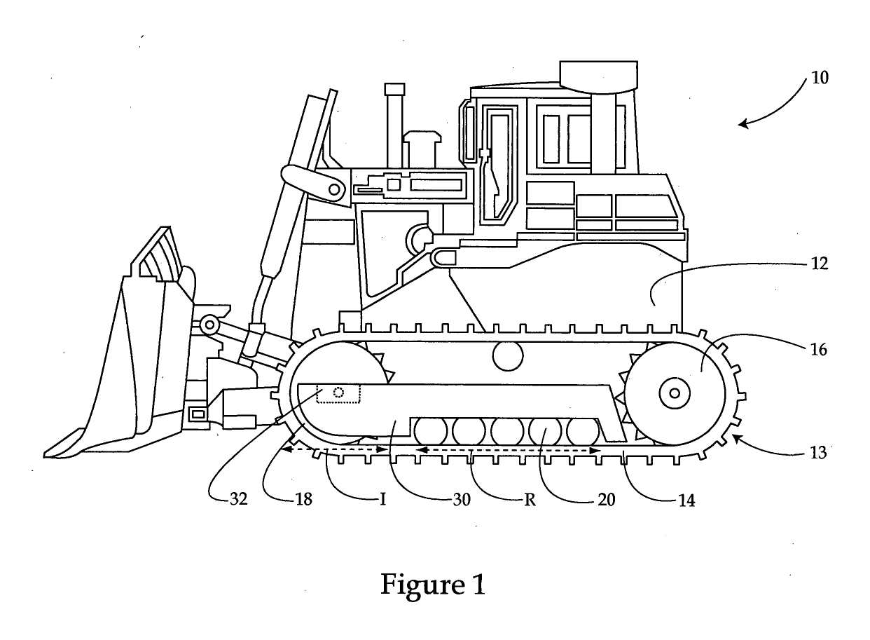

Referring to FIG. 1, there is shown a work machine 10 that includes a work machine body 12 having a track assembly 13 mounted thereto. Track assembly 13 preferably includes a track roller frame 30 and a track 14. Track 14 preferably includes a plurality of links pivotably coupled to one another, and extends about a drive sprocket 16, idler 18, and a plurality of rollers 20. A vertical idler adjuster 32 is preferably positioned proximate an end of roller frame 30 and is operable to adjust a vertical position of idler 18 relative to roller frame 30. An idler plane “I” extends along the bottom of idler 18, whereas a roller plane “R” extends along the bottoms of rollers 20. Each of planes I and R pass through bushings (not shown) in track 14.

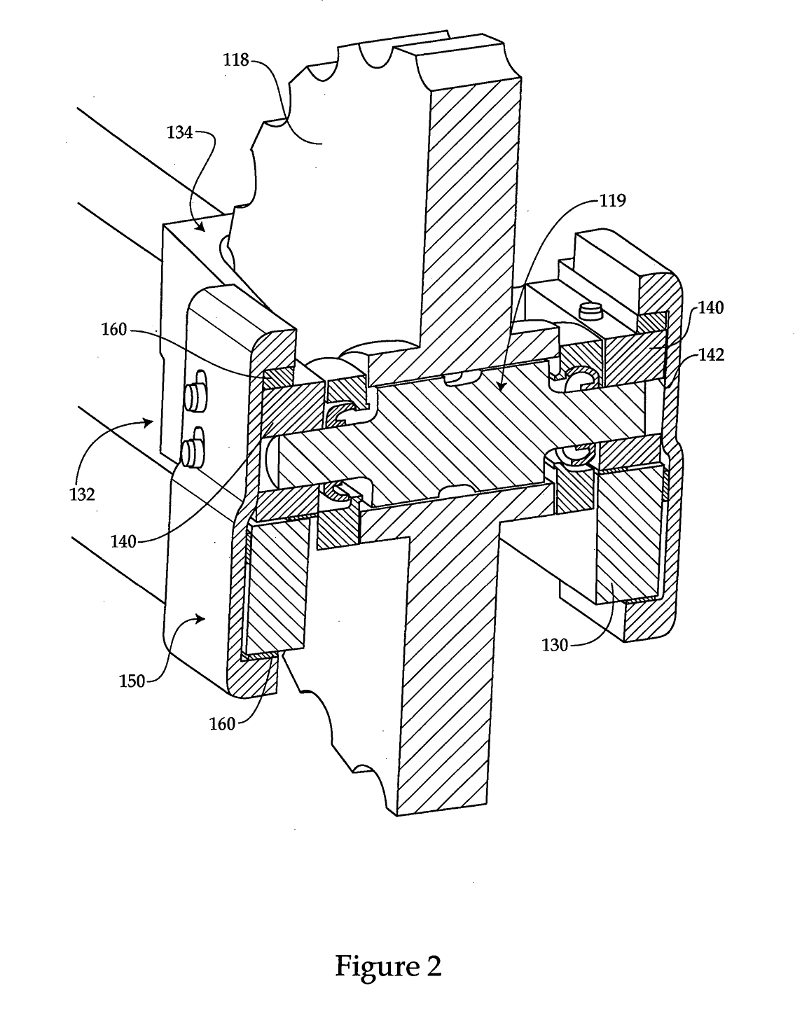

Turning to FIG. 2, there is shown a vertical idler adjuster 132 and an idler 118 mounted on a roller frame 130. In a preferred embodiment, idler 118 rotates about an idler shaft 119, and is slidable along wear strips 160 disposed on roller frame 130. Idler 118 is preferably coupled with an idler yoke 134 that supports the same, idler yoke 134 in turn being coupled with a track tensioning mechanism (not shown) in a conventional manner.

Vertical idler adjuster 132 preferably includes first and second support blocks 140 disposed at opposite ends of idler shaft 119 and coupled with idler yoke 134. In a preferred embodiment, a retainer hook 150 is positioned on each side of idler shaft 119 and slidably couples the same with roller frame 130. Each of support blocks 140 includes an eccentric aperture 142 within which the respective ends of idler shaft 119 are positioned. Support blocks 140 are positionable in at least a first assembly orientation, as shown in FIG. 2, wherein each eccentric aperture 142 is relatively closer to roller frame 130, and a second, inverted assembly orientation, wherein apertures 142 are relatively further from roller frame 130.

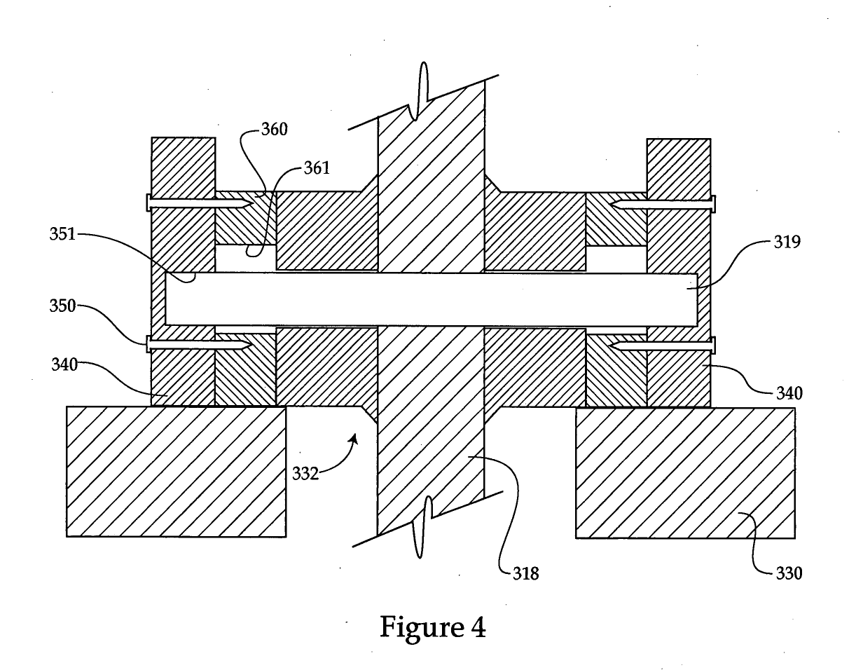

Turning to FIG. 4 there is shown another preferred embodiment of a vertical idler adjuster 332 according to the present disclosure. Vertical idler adjuster 332 is used to adjust a vertical position of an idler 318 and its idler shaft 319 relative to a roller frame 330. In a preferred embodiment, vertical idler adjuster 332 includes first and second support blocks 340 disposed at opposite ends of idler shaft 319, similar to idler adjuster 132 of FIG. 2. Support blocks 340 preferably slidably support idler 318 on roller frame 330 in a manner similar to that of the embodiment of FIG. 2. Idler adjuster 332 differs from the embodiment of FIG. 2, however, primarily in the manner in which support blocks 340 are mounted.

Support blocks 340 are preferably outer blocks, and are coupled with inner blocks 360 via a plurality of removable fasteners 350. Each of support blocks 340 further includes an eccentric aperture 351 that supports an end of idler shaft 319. Vertical idler adjuster 332 preferably has a plurality of assembly orientations, including that shown in FIG. 4, wherein eccentric apertures 351 are relatively closer to roller frame 330, and an inverted assembly orientation wherein blocks 340 are inverted and eccentric apertures 351 are relatively further from roller frame 330.

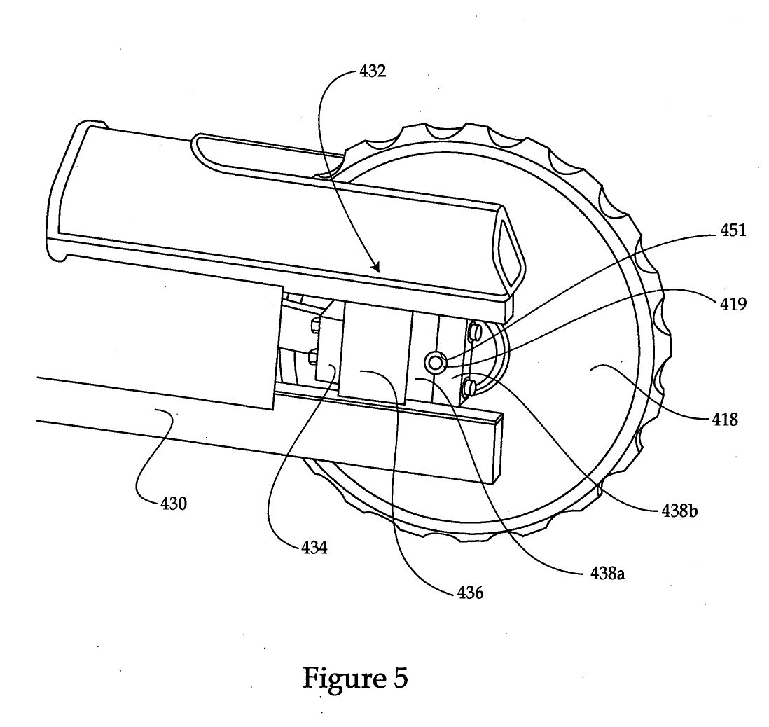

Turning to FIG. 5, there is shown a side view of one portion of a vertical idler adjuster 432 according to yet another embodiment of the present disclosure. Only one side of idler adjuster 432 is shown, however, it should be appreciated that a portion of idler adjuster 432 opposite that shown (on the opposite side of an idler 418) is preferably substantially identical. Thus, those skilled in the art will appreciate that description herein of components on one side of the respective idler 418 is similarly applicable to components on the other side thereof.

Vertical idler adjuster 432 preferably includes a positioning block 436 coupled with an idler yoke 434. Positioning block 436 slides in between top and bottom rails of a track roller frame 430. Front 438b, and rear 438a support blocks are preferably coupled via block 438a with positioning block 436. Blocks 438a and 438b support an end of idler shaft 419 in an eccentric aperture 451, defined in part by each of blocks 438a and 438b. Idler 418 is mounted on idler shaft 419 in a conventional manner, and its position relative to roller frame 430 can be adjusted by placing vertical idler adjuster 432 in a selected one of a plurality of assembly orientations. A horizontal plane extending through idler shaft 419, identified as Plane O, represents a vertical position of the axis of rotation of idler 418 relative to roller frame 430. Adjustment of vertical idler adjuster 432 can adjust the relative position of Plane O with respect to roller frame 430.

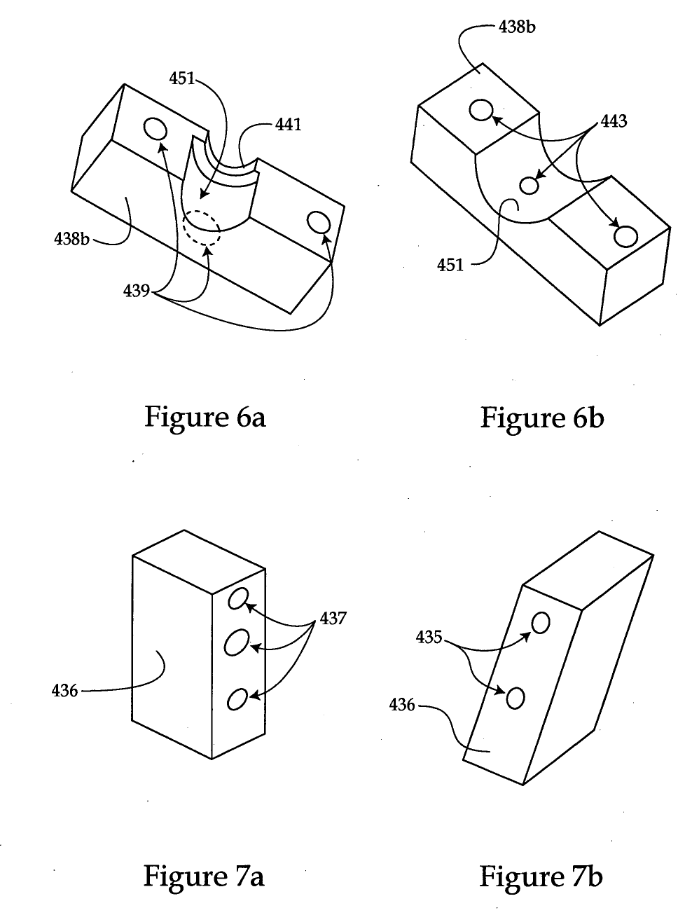

FIG. 6a illustrates rear support block 438a, including a plurality of mounting apertures 439 disposed therein for coupling the same with positioning block 436. Rear block 438a further preferably includes a lip or wall 441 positionable about an end of idler shaft 419 when supported therein. FIG. 6b illustrates front support block 438b, and a plurality of mounting apertures 443 disposed therein. Thus, support blocks 438a and 438b assembled together define eccentric aperture 451, which supports idler shaft 419. A position of aperture 451 relative to roller frame 430 defines the vertical position of the axis of rotation of idler 418. Mounting apertures 439 and 443 are preferably symmetric about aperture 451. Support blocks 438a and 438b are preferably removably coupled with positioning block 436, and can be inverted relative thereto between first and second assembly orientations of vertical idler adjuster 432 to position aperture 451 at either of two different vertical positions relative to roller frame 430.

FIGS. 7a and 7b illustrate perspective views of opposite ends of positioning block 436, including mounting apertures 437 in a first end thereof, and mounting apertures 435 in a second end thereof. Mounting apertures 435 and 437 provide for coupling of positioning block 436 to idler yoke 434 and rear support block 438a, respectively. FIG. 7c illustrates a vertical offset of mounting apertures 437 and 435 with respect to an approximate centerline C of block 436. The relative offset of apertures 437 and 435 with respect to centerline C is preferably the same or similar to the vertical offset of aperture 451 in rear support blocks 438a and 438b, in other words the relative vertical offset of aperture 451 with respect to a vertical center of blocks 438a and 438b. Positioning block 436 can be decoupled from idler yoke 434 and inverted to position idler shaft 419 at a different vertical position relative to roller frame 430 (and Plane O) thus creating two additional assembly orientations of vertical idler adjuster 432, for a total of four. It should be appreciated that although vertical idler adjuster 432 is described in the context of having vertically offset mounting “apertures,” the described vertical offset could also refer to mounting pegs or similar coupling structures.

The embodiment of FIGS. 6a-6b in combination with the components of FIGS. 7a-7c thus provides four different assembly orientations. The relative vertical position of eccentric aperture 451, and the vertical offset of apertures 435 and 437 can be selected such that each assembly orientation positions idler shaft 419 at a different vertical position relative to roller frame 430.

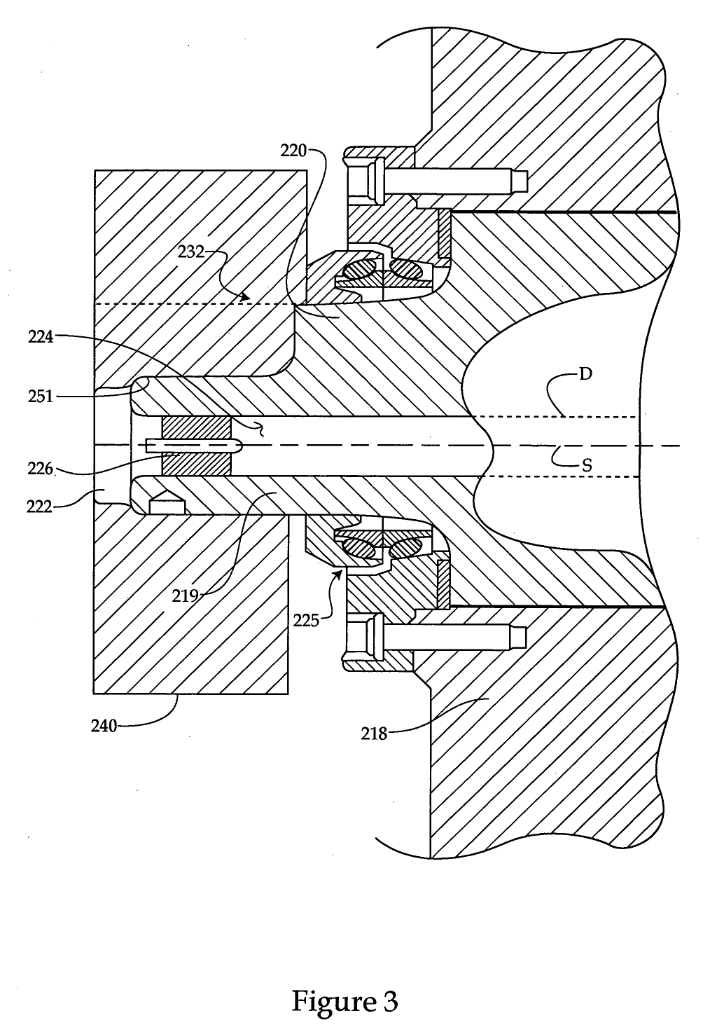

Turning now to FIG. 3, there is shown yet another embodiment of the present disclosure, including a vertical idler adjuster 232. Vertical idler adjuster 232 includes an idler shaft 219 having a longitudinal axis “S” that is offset from an axis of rotation “D” of an idler 218. In other words, axis 5 is eccentrically arranged with respect to idler 218. In other words, axis 5 is eccentrically arranged with respect to idler 218. In a preferred embodiment, vertical idler adjuster 232 is adjustable in a support block 240, to radially reposition axis S relative to axis D, for example by repositioning axis S from below axis D to a position vertically above the same. In a preferred embodiment, idler shaft 219 includes an offset or a shoulder 220 supported in support block 240. A hex 222 or similar non-circular component is disposed on an end of idler shaft 219, and is preferably engageable with support block 240 to assist in fixing idler shaft 219 in one of at least two vertical positions relative to support block 240, in a support aperture 251 disposed therein. In a preferred embodiment a stopper 226 is positioned behind hex 222 and seals an oil cavity 224 extending in shaft 219 and containing a supply of lubricating oil for idler 218 and associated internal components. A seal assembly 225 is preferably provided and extends about idler shaft 219.

### INDUSTRIAL APPLICABILITY

Referring to the drawing Figures generally, work machine 10 will over the course of a period of operation experience wear of various components, including track 14 and rollers 20. Accordingly, after a certain time, idler plane I may lie in a position relative to roller plane R that differs from its desired position. To continue working within desired specifications, it will be desirable to vertically adjust the position of idler plane I relative to roller plane R, restoring the same to the desired relative positions, typically by raising idler 18, 118, 218, 318, 418 relative to roller frame 30, 130, 230, 330, 430. Idler adjuster 32, 132, 232, 332, 432 is used to vertically adjust idler 18, 118, 218, 318, 418 to compensate for a faster rate of change in the position of roller plane R than in idler plane I. Each of the embodiments herein includes a plurality of assembly orientations corresponding to different vertical heights of the respective idler and idler plane. Preferably, the various idler adjuster components may be re-positioned from one angular orientation about the respective idler rotation axis to at least a second angular orientation.

Idler plane translation is a function of bushing and tooth root wear, whereas roller plane translation is a function of roller and link wear. In earlier designs, using non-rotating bushings, the translation of the work machine's idler plane was faster. With the advent of rotating bushings idler plane translation in many systems has slowed while translation of the roller plane continues at approximately the same rate. In some instances, the translation rate of roller plane R may be about five times the translation rate of idler plane I. For example, where roller plane R translates 10 mm, idler plane I may translate only about 2 mm, a difference of about 8 mm. In certain applications, an 8 mm departure, or less, from specifications in the relative positions of planes R and I can affect operation.

Referring in particular to FIG. 2, when it is desirable to vertically adjust a position of idler 118 relative to roller frame 130, a jack or similar support will be placed under idler 118 to relieve pressure/weight thereon. Subsequently, hook retainers 150 will be removed. It is preferred to vertically adjust idler 118, and all of the idlers described herein, without de-coupling the links of track 14. Thus, access to vertical idler adjuster 132 may be from sides of roller frame 130 by way of “windows” in roller frame 130 or side plates (not shown) connected therewith.

Once hook retainers 150 are removed, support blocks 140 are removed, inverted, and repositioned about idler shaft 119. Idler 118 can generally be jacked to its desired vertical position once hook retainers 150 are removed, however, this step can take place following, or prior to removal and inverting of support blocks 140. Inverting support blocks 140 vertically repositions eccentric apertures 142 relative to roller frame 130. Thus, once support blocks 140 are inverted, idler 118 may be returned to rest on roller frame 130 at its adjusted vertical position and hook retainers 150 repositioned.

It should be appreciated that the relative position of eccentric apertures 142 in support blocks 140 might be selected based on a projected service schedule of work machine 10. In other words, the degree of “eccentricity” of apertures 142 can be selected based on an estimated number of operating hours of work machine 10 and an estimated wear rate of the respective track components. For example, if it is estimated that idler 118 will need to be vertically adjusted a certain vertical distance after a certain number of operating hours, apertures 142 can be offset from a center of the respective support block 140 a corresponding distance. In this manner, designers can set the vertical idler adjustment schedule to coincide with other service tasks. Similar considerations apply to all of the vertical idler adjuster embodiments disclosed herein.

Turning to FIG. 3, when it is desirable to vertically reposition idler 218, access to vertical idler adjuster 232 is first obtained, for example by removing side plates on roller frame 230, etc. Subsequent or prior to accessing vertical idler adjuster 232, idler 218 may be jacked to remove pressure thereon. Hex 222 is next disengaged from support block 240 such that idler shaft 219 can be rotated relative to support block 240. It should be appreciated that a wide variety of designs might be used for fixing shaft 219 relative to support block 240, including set screws against hex 222, shims disposed between an outer side of hex 222 and support block 240, etc. Once shaft 219 is free to rotate, a tool may be engaged with hex 222 or another part of idler shaft 219 and used as a lever to rotate idler 218 to a desired position relative to the respective roller frame. A jack or similar device may be used to facilitate repositioning of idler 218, in cooperation with the tool. Rotation of idler shaft 219 will reposition shoulder 220 against support block 240 such that idler 218 rests at a raised vertical position relative to the respective roller frame. Hex 222 can then be re-locked against support block 240 by any suitable means.

Although vertical idler adjuster 232 is described in the context of a single hex 222, and rotation/adjustment of idler 218 from only one side thereof, those skilled in the art will appreciate that embodiments are possible, and may even be preferred, wherein mirror-image vertically offset shafts 219 and hexes 222 are disposed on both sides of idler 218.

Referring to FIG. 4, adjustment of a vertical position of idler 318 takes place in a manner similar to that described with respect to vertical idler adjuster 132 of FIG. 2. Support blocks 340 are disengaged from inner blocks 360 and idler shaft 319, idler shaft 319 and idler 318 are raised relative to roller frame 330, blocks 340 are inverted, and reattached to inner blocks 360 to support idler 318 at a higher vertical position relative to roller frame 330. Inner blocks 360 preferably include apertures 361 that are sufficiently larger in diameter than idler shaft 319 that they can accommodate the same at either of the possible vertical positions.

Referring to FIG. 5, vertical idler adjuster 432 differs from the foregoing embodiments primarily in that it has a larger number of possible assembly orientations. Positioning block 436 may be coupled with idler yoke 434 in either of two positions, each of which positions its rear block coupling apertures, preferably apertures 435, at different vertical positions relative to roller frame 430. Rear support block 438a is preferably configured to couple with positioning block 436 at either of its orientations and, accordingly, will position idler 418 via its support of idler shaft 419 at either of two vertical positions relative to roller frame 430.

Front and rear support blocks 438a and 438b can also be inverted relative to roller frame 430 and, accordingly, can provide two more possible vertical idler positions by repositioning eccentric aperture 451. Vertical idler adjuster 432 can thus be used to incrementally raise or lower idler 418 by re-configuring positioning block 436 and front and rear support blocks 438a and 438b among their various assembly orientations.

By selecting offset coupling means, for example, including one or both of apertures 435 and 437 of positioning block 436, and apertures 439 of rear support block 438a, multiple assembly orientations can be created. Embodiments are contemplated wherein the degree of eccentricity of aperture 451, and the degree of vertical offset of the various mounting apertures are all selected to provide assembly orientations to incrementally raise or lower idler 418 as desired. For example, inverting either one of positioning block 436, or support blocks 438a and 438b, might raise idler 418 the same height, thus providing for at least two equal vertical adjustments. In contrast, inverting positioning block 436, or alternatively support blocks 438a and 438b, might provide different vertical height adjustments of idler 418, for example, an initial relatively large adjustment, and one or more subsequent, relatively fine adjustments.

The present description is for illustrative purposes only, and should not be construed to narrow the breadth of the present disclosure in any way. Thus, those skilled in the art will appreciate that various modifications might be made to the presently disclosed embodiments without departing from the intended spirit and scope of the present disclosure. For example, while the above description is primarily concerned with raising an idler height to compensate for wear, some applications might call for decreasing a relative idler height, to which the presently disclosed embodiments are well suited. Further, although several of the embodiments are discussed in the context of having only two assembly orientations, additional orientations might be possible. For example, rather than simply inverting support blocks 140 and 340, they might be rotated 90 degrees to provide a more moderate vertical adjustment than that available by inverting the same. Other aspects, features and advantages will be apparent upon an examination of the attached drawing figures and appended claims.

What is claimed is:

1. A track type work machine comprising:
a roller frame;
an idler mounted proximate an end of said roller frame, said idler having an idler shaft;
at least one support block supporting said idler shaft;
wherein one or both of said idler shaft and said at least one support block includes a plurality of assembly orientations corresponding to different idler heights relative to said roller frame.

2. The track type work machine of claim 1 wherein each of said assembly orientations corresponds to a different angular orientation relative to an axis of rotation of said idler.

3. The track type work machine of claim 2 wherein said at least one support block includes first and second support blocks disposed at opposite ends of said idler shaft, said support blocks being invertable relative to said roller frame to vertically reposition said idler relative thereto.

4. The track type work machine of claim 3 wherein said first and second support blocks each define an eccentric aperture for receipt of an end of said idler shaft.

5. The track type work machine of claim 4 wherein said first and second support blocks are outer blocks removably coupled with first and second inner blocks, respectively.

6. The track type work machine of claim 2 wherein:
said idler shaft is offset from a rotation axis of said idler;
said idler shaft is supported in said at least one support block and positionable in plural radial orientations relative to said rotation axis; and
said idler shaft comprises first and second ends, at least one of said first and second ends including a non-cylindrical shape.

7. The track type work machine of claim 2 wherein said at least one support block comprises at least four support blocks, said at least four support blocks having among them at least four assembly orientations corresponding to different idler heights.

8. The track type work machine of claim 7 wherein said at least four support blocks includes:
first and second pairs of adjacent front and rear support blocks disposed at opposite ends of said idler shaft, said first and second pairs each defining an eccentric idler shaft support aperture; and
first and second re-orientable positioning blocks disposed between said idler yoke and said first and second pairs of front and rear support blocks, each of said first and second re-orientable positioning blocks including vertically offset coupling means with at least one of said idler yoke and said first and second pairs, respectively.

9. An idler mounting apparatus for a track type work machine comprising:
a roller frame;
an idler yoke disposed proximate an end of said roller frame;
a rotatable idler supported in said idler yoke and including an idler shaft;
first and second support blocks supporting said idler shaft;
at least one of said idler shaft and said first and second support blocks having a plurality of assembly orientations corresponding to a plurality of vertical idler positions relative to said roller frame.

10. The idler mounting apparatus of claim 9 wherein said idler shaft is offset from said axis of rotation of said idler.

11. The idler mounting apparatus of claim 9 wherein said first and second support blocks each include an eccentric aperture receiving an end of said idler shaft.

12. The idler mounting apparatus of claim 11 wherein said first and second support blocks are invertable outer blocks coupled with first and second inner blocks, respectively.

13. The idler mounting apparatus of claim 11 wherein said first and second support blocks each comprise a set of separable front and rear block portions, each defining one half of the respective eccentric aperture.

14. The idler mounting apparatus of claim 9 comprising:
first and second removable positioning blocks disposed between said idler yoke and said first and second pairs of front and rear support blocks;
each of said first and second removable positioning blocks including a portion of a vertically offset coupling arrangement with at least one of said idler yoke and said first and second pairs of support blocks.

15. The idler mounting apparatus of claim 14 wherein each of said positioning blocks comprises at least one of: mounting apertures arranged vertically asymmetrically and adapted to receive a mounting member; and, one or more mounting members arranged vertically asymmetrically.

16. A method of vertically adjusting a rotatable idler in a track type work machine comprising the steps of:
relieving pressure on the idler;
re-orienting at least one of an idler shaft and at least one support block supporting said idler shaft to vertically reposition the same relative to a roller frame of the work machine; and
returning pressure to the idler.

17. The method of claim 16 wherein the step of re-orienting comprises:
decoupling the at least one support block from the idler;
rotating the at least one support block about 180 degrees to adjust a vertical position of an eccentric aperture therein relative to the roller frame; and
re-coupling the at least one support block with the idler.

18. The method of claim 16 comprising the steps of:
decoupling at least one positioning block from at least one of an idler yoke and the at least one support block, the at least one positioning block having a vertically offset coupling with one or both of the at least one support block and an idler yoke;
inverting the at least one positioning block; and
re-coupling the at least one positioning block with the one or both of the at least one support block and the idler yoke.

19. The method of claim 16 wherein the step of re-orienting comprises radially adjusting the idler shaft about the axis of rotation of the idler.
